(19) United States
(12) Patent Application Publication
(10) Pub. No.: US 2009/0169149 A1
(43) Pub. Date: Jul. 2, 2009

(54) STABILIZED RING RESONATOR MODULATOR

(76) Inventor: Bruce Andrew Block, Portland, OR (US)

Correspondence Address: INTEL CORPORATION;c/o CPA Global, P.O. BOX 52050, MINNEAPOLIS, MN, 55402, US

(21) Appl. No.: 11/965,216

(22) Filed: Dec. 27, 2007

(51) Int. Cl. G02F 1/295

(52) U.S. Cl. 385/9

(57) ABSTRACT

An optical ring resonator modulator comprises a circular waveguide, or ring, evanescently coupled to a first straight waveguide and a second straight waveguide. The ring may be surrounded by an outer ring or member of doped silicon and the region inside the ring may comprise an oppositely doped member, making the ring itself the intrinsic region of a positive-intrinsic-negative (PIN) diode. When a voltage is applied between the outer and inner members the refractive index of the waveguide is changed. A photodiode at a throughput end of the first waveguide is connected to a feedback loop that controls the voltage to the members.

### FIELD OF THE INVENTION

Embodiments of the present invention are directed to optical ring resonators and, more particularly is directed to a ring resonator modulator with improved stability.

### BACKGROUND INFORMATION

Ring resonators are wavelength selective devices which may be used for various optical filter and modulation applications. Optical Ring Resonators (RRs) are useful components for wavelength filtering, multiplexing, switching, and modulation. The key performance characteristics of the RR includes the Free-Spectral Range (FSR), the finesse (or Q-factor), the resonance transmission, and the extinction ratio. These quantities depend not only on the device design but also on the fabrication tolerance. Although state-of-the-art lithography may not be required for most conventional waveguide designs, Ring Resonator designs involve critical dimension (CD) values at or below 100 nm.

For such designs, resolution and CD control are both important to the success of the devices. In the case of Si based ring resonators, one of the important parameters to control is the coupling efficiency between the RR and the input/output waveguide. As a compact waveguide (for example, 220 nm×500 nm strip waveguide) is usually used in the RR to obtain a large FSR, the gap between the ring and bus waveguide may only be 100-200 nm. Since the device operates through evanescent coupling, the coupling is exponentially dependent on the size of the separating gap. Thus, in order to reliably process high-Q RR devices, control of a few nm demands CD control readily achieved by modern 0.18 μm or 0.13 μm lithography.

Since the ring resonators are by their very nature very sensitive devices, there are many things that could require re-adjustment. Some things which could cause a “de-tuning” of the resonance include but are not limited to temperature variations, process variations, materials degradation, voltage droop, strain, wavelength drift of the laser, etc.

### BRIEF DESCRIPTION OF THE DRAWINGS

The foregoing and a better understanding of the present invention may become apparent from the following detailed description of arrangements and example embodiments and the claims when read in connection with the accompanying drawings, all forming a part of the disclosure of this invention. While the foregoing and following written and illustrated disclosure focuses on disclosing arrangements and example embodiments of the invention, it should be clearly understood that the same is by way of illustration and example only and the invention is not limited thereto.

FIG. 1 is view of an optical ring resonator; and

FIG. 2 is a view of an optical ring resonator modulator with a feedback control loop to provide stability.

### DETAILED DESCRIPTION

In the following detailed description, like reference numerals and characters may be used to designate identical, corresponding or similar components in differing FIG. drawings. Well-known power/ground connections to integrated circuits (ICs) and other components may not be shown within the figures for simplicity of illustration and discussion. Where specific details are set forth in order to describe example embodiments of the invention, it should be apparent to one skilled in the art that the invention can be practiced without these specific details.

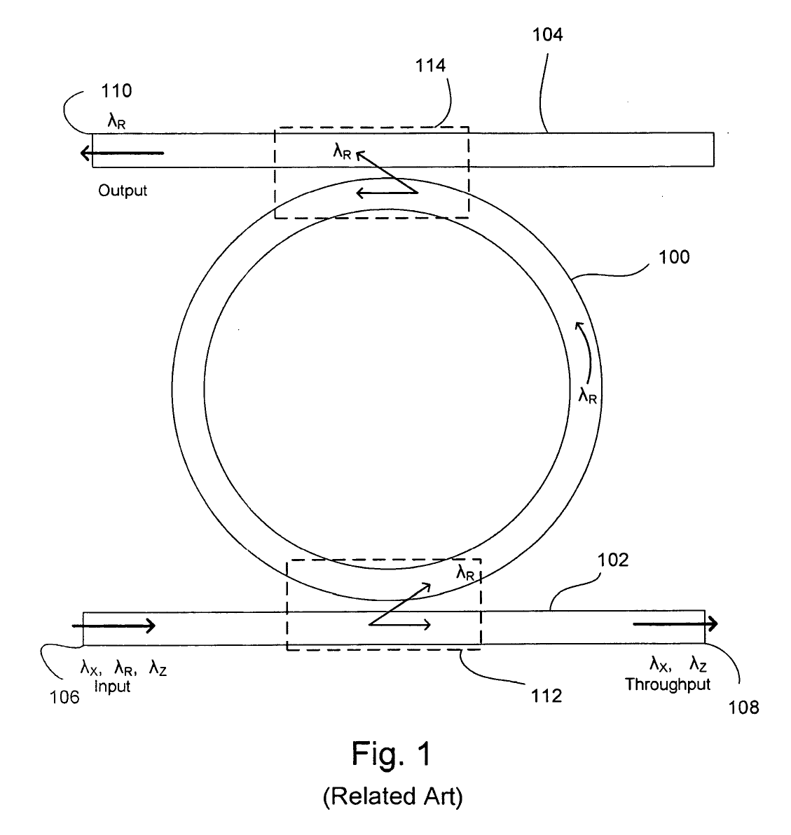

An example of a micro-ring resonator is shown in FIG. 1. The ring resonator comprises a circular waveguide, or ring, 100 evanescently coupled to a first straight waveguide 102 and a second straight waveguide 104. For purposes of illustration, the ring resonator comprises three main terminals; an input terminal 106, a throughput terminal 108, and an output terminal 110. In operation, multiple wavelengths of light are launched into the input terminal 106 of the first straight waveguide 102. Here, three wavelengths are shown, those being λx, λR, and λz. As the wavelengths pass through the first coupling area 112, they will be partially coupled into the ring 100 and the wavelengths in the ring 100 will then be in turn partially coupled at the second coupling area 114 into the second straight waveguide 104 to be output at the output terminal 110.

Thus, a ring resonator is a device which works by having a very narrow band where light of a particular wavelength is in resonance with the ring and that light gets coupled into the ring 100. Here, the resonant wavelength λR is the wavelength that is coupled into the ring 100 since it satisfies the condition λR=LN_{eff}/m, were L is the length of the ring 100, N_{eff} is the effective index of the ring 100 and m is an integer value. With this device, multiple wavelengths go into the ring resonator device, and all may be filtered out but the wavelength of interest, or resonant wavelength, λR.

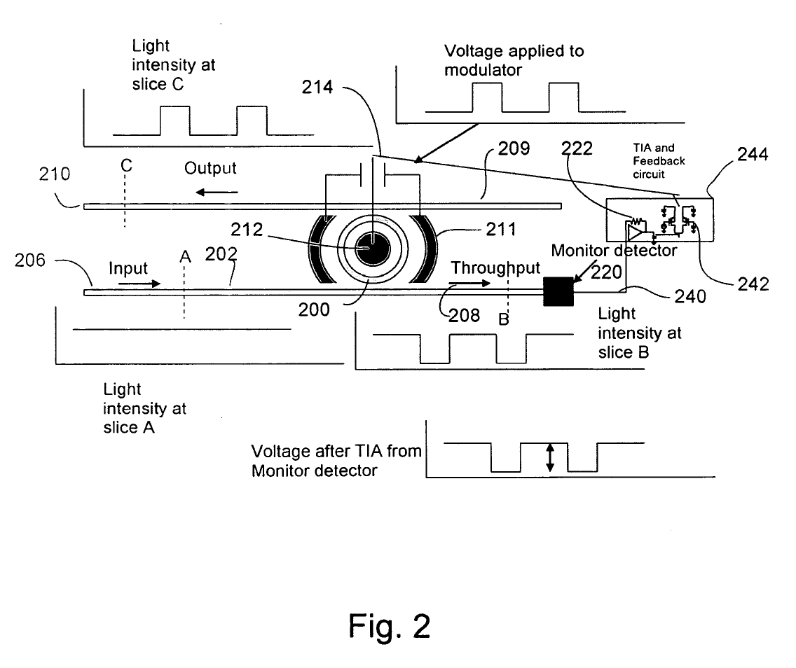

Referring now to FIG. 2, there is shown a ring resonator according to one embodiment of the invention. As before, the ring resonator comprises a circular waveguide, or ring, 200 evanescently coupled to a first straight waveguide 202 and a second straight waveguide 204. The ring resonator may comprise three main terminals; an input terminal 206, a throughput terminal 208, and an output terminal 210.

Different modulation methods may be employed by changing the refractive index of the waveguide or the cladding of the ring 200, thus changing the resonance frequency. For example this may be accomplished by thermal tuning or using an electro optic material such as a chromophore doped polymer or semiconductor whose index can be changed by injecting (or removing) free carriers. Other electro optic material options are also available, as well as other tuning options.

As shown in the example of FIG. 2, the ring 200 is surrounded by an outer ring 211 of negatively doped silicon, and the region 212 inside the ring is positively doped, making the waveguide itself the intrinsic region of a positive-intrinsic-negative (PIN) diode. Of course the doping may be an opposite scheme with the outer ring 211 being positively doped and the regions inside 212 the ring being negatively doped. When a voltage is applied across the junction at terminals 214, electrons and holes are injected into the ring waveguide 200, changing its refractive index and its resonant frequency so that it no longer passes light at the same wavelength. As a result, turning the voltage on switches the light beam off acting a switch.

According to an embodiment, an integrated monitor photodetector, or photodiode, 220 may be placed to capture the light from the throughput port 208. The photodiode 220 at the throughput port 208 essentially sees the inverse intensity of light at the output port 210. The photodiode 220 translates the signal intensity from the optical domain to the electrical domain. A feed back circuit including a transimpedance amplifier (TIA) 222 then translates the electrical current received from the photodiode 220 to an electrical voltage which may be applied to the terminals to modulate light in the ring 214.

As illustrated in FIG. 2, if one could look at the light at the resonance frequency passing through a slice of the first waveguide 202 after the input port 206, “slice A”, the light intensity would appear fairly steady. The intensity of modulated light after the ring 200 passing through the throughput port 208 at “slice B” may alternate on and off as shown depending on the resonance conditions of the ring as modulated by the voltage applied at terminals 214. This is the light intensity that is detected by the monitor photodiode 220. When the wavelength of light is resonant with the ring cavity, light is coupled into the ring 200 and the intensity drops at the throughput port 208 and rises at the output port 210 as shown by the waveform of “slice C”. When the wavelength of light is out of resonance, the intensity of light at the output port 210 is at a minimum and intensity of light at the throughput port 208 is at a maximum.

The photodiode 220 at the end of the throughput port 208, reading this light, outputs a signal 240 that may be connected to CMOS circuits 242 to amplify the signal through the transimpedance amplifier (TIA) 222 or other amplifier. A feedback circuit 244 may read the difference between the on and off state and then apply a voltage to the control electrodes 214 of the ring modulator to maximize this difference. The real time feedback circuit thus aids in maintaining stability and maximize performance of ring modulators, which are by nature very sensitive to small changes in refractive index caused for example by processing variations and thermal drift.

The above description of illustrated embodiments of the invention, including what is described in the abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. An optical ring resonator modulator, comprising:
a first waveguide having an input terminal at a first end and a throughput terminal at a second end;
a second waveguide having an output port at one end;
an optical ring to evanescently couple the first waveguide to the second waveguide;
means for changing the refractive index of the optical ring;
a light monitoring device at the throughput terminal to monitor light having an inverse intensity of light at the output port; and
a feedback circuit to control the means for changing the refractive index of the optical ring in response to an output of the light monitoring device.

2. The optical ring resonator modulator as recited in claim 1, wherein said feedback circuit comprises a transimpedance amplifier (TIA).

3. The optical ring resonator modulator as recited in claim 2 wherein the means for changing the refractive index comprises:
an outer ring at least partially surrounding the optical ring and an inner region within the center of the optical ring, the outer ring and the inner region to receive a voltage signal from the feedback circuit.

4. The optical ring resonator modulator as recited in claim 3 wherein the outer ring comprises negatively doped silicon and the inner regions comprise positively doped silicon to make the optical ring an intrinsic region of a positive-intrinsic-negative (PIN) diode.

5. The optical ring resonator modulator as recited in claim 3 wherein the outer ring comprises positively doped silicon and the inner region comprises negatively doped silicon to make the optical ring an intrinsic region of a positive-intrinsic-negative (PIN) diode.

6. The optical ring resonator modulator as recited in claim 3 wherein the means for changing the refractive index of the optical ring is a thermal tuner.

7. A method for maximizing light intensity output from a ring resonator modulator, comprising:
inputting a light signal into an input terminal of a first waveguide;
evanescently coupling the light signal in the first waveguide to a ring resonator when the light signal satisfies a resonant condition of the ring resonator;
passing light that does not satisfy the resonant condition through the first waveguide to a throughput terminal;
monitoring the intensity of the light at the throughput terminal having an inverse intensity of light at the output port produce a control signal; and
changing the resonant condition of the ring resonator with the control signal.

8. The method as recited in claim 7 wherein the changing a resonant condition of the ring resonator comprises:
placing a first doped member around the optical ring;
placing a second doped member within the center of the optical ring; and
passing a voltage to the first doped member and the second doped member.

9. The method as recited in claim 8 wherein the first doped member comprises negatively doped silicon and the second doped member comprises positively doped silicon.

10. The method as recited in claim 8 wherein the first doped member comprises positively doped silicon and the second doped member comprises negatively doped silicon.

11. The method as recited in claim 8 wherein the monitoring comprises placing a photodiode at the throughput terminal.

12. The method as recited in claim 8 further comprising:
connecting the control signal to control a thermal device to change the temperature of the ring.

13. A system for modulating light, comprising:
a first waveguide to carry a light signal comprising a plurality of different wavelengths;
an input terminal at a first end of the first waveguide and a throughput terminal at a second end of the first waveguide;
a second waveguide having an output terminal at one end;
an optical ring evanescently coupled to the first waveguide and to the second waveguide;
means for changing the refractive index of the optical ring;
a light monitoring device at the throughput terminal to monitor light having an inverse intensity of light at the output port; and
a feedback circuit to control the means for changing the refractive index of the optical ring in response to the output of the light monitoring device to modulate a resonant wavelength between the input terminal and the output terminal.

14. The system as recited in claim 13, wherein said feedback circuit comprises a transimpedance amplifier (TIA).

15. The system as recited in claim 13 wherein the means for changing the refractive index comprises:
an outer ring at least partially surrounding the optical ring and an inner region within the center of the optical ring, the outer ring and the inner region to receive a voltage signal from the feedback circuit.

16. The system as recited in claim 15 wherein the outer ring comprises negatively doped silicon and the inner regions comprise positively doped silicon to make the optical ring an intrinsic region of a positive-intrinsic-negative (PiN) diode.

17. The system as recited in claim 15 wherein the outer ring comprises positively doped silicon and the inner region comprises negatively doped silicon to make the optical ring an intrinsic region of a positive-intrinsic-negative (PIN) diode.

18. The system as recited in claim 15 wherein means for changing the refractive index of the optical ring is a thermal tuner.

19. The system as recited in claim 13 wherein the photo monitoring device comprises a photodiode.

20. The system as recited in claim 13 wherein the optical ring comprises a chromophore doped polymer.
